(19) United States
(12) Patent Application Publication
(10) Pub. No.: US 2026/0093478 A1
(43) Pub. Date: Apr. 2, 2026

(54) CONTAINER IMAGE UPDATE WITH DEDUPLICATION

(71) Applicant: Red Hat, Inc., Raleigh, NC (US)

(72) Inventors: Douglas Landgraf, Tallahassee, FL (US); Giuseppe Scrivano, Milan (IT)

(73) Assignee: Red Hat, Inc., Raleigh, NC (US)

(21) Appl. No.: 18/904,728

(22) Filed: Oct. 2, 2024

(51) Int. Cl. G06F 8/65; G06F 16/174

(52) U.S. Cl. CPC G06F 8/658; G06F 16/152

(57) ABSTRACT

A source container image may be replaced with a target container image that has a different number of layers. A computing device can receive an update request to generate the target container image using the source container image. Subsequently, the computing device can determine, for a particular file of the target container image, whether the source container image includes a related file. In response to determining that the source container image includes the related file, the computing device can generate a dataset corresponding to the related file. The dataset can include one or more differences between the particular file and the related file and an identifier used to locate the related file in the source container image. The computing device can generate the target container image by updating the source container image using the dataset.

### TECHNICAL FIELD

The present disclosure relates generally to software updates. More specifically, but not by way of limitation, this disclosure relates to updating a container image with deduplication.

### BACKGROUND

Software programs such as applications and microservices can be deployed inside containers. A container is a relatively isolated virtual environment created by leveraging the resource isolation features (e.g., cgroups and namespaces) of the Linux Kernel. Deploying software programs inside containers can help isolate the software programs from one another and provide other benefits.

Containers are deployed from image files using a container engine, such as Docker®. These image files are often referred to as container images. A container image can be conceptualized as a stacked arrangement of layers in which a base layer is positioned at the bottom and other layers are positioned above the base layer. The base layer may include operating system files for deploying a guest operating system inside the container. The guest operating system may be different from the underlying host operating system of the physical machine on which the container is deployed. The other layers may include a target software program and its dependencies, such as its libraries, binaries, and configuration files. The target software program may be configured to run (e.g., on the guest operating system) within the isolated context of the container.

### BRIEF DESCRIPTION OF THE DRAWINGS

FIG. 1 is a block diagram of an example of a computing environment for updating a container image with deduplication according to some examples of the present disclosure.

FIG. 2 is a block diagram of an example computing device for updating a container image with deduplication according to some examples of the present disclosure.

FIG. 3 is a flowchart of a process for updating a container image with deduplication according to some examples of the present disclosure.

### DETAILED DESCRIPTION

A container image may be designed to deploy a software program in a computing environment. The container image can be updated, such as to resolve a vulnerability. Updating the container image can involve creating a new container image to replace a previous version of the container image. But providing the new container image can be resource intensive, such as by consuming unnecessary amounts of storage. In particular, the new container image can include files or layers that are unchanged from the previous version of the container image. Additionally, software tools used to differentiate between layers of the container image may have certain limitations. In some cases, the software tools may only be usable with container images including one layer. The software tools may generate an output, such as a file or a set of instructions, that indicates differences between contents of different container layers. But the software tools may only have functionality to apply the output from one container layer to another container layer. In other words, the software tools may be unable to generate an updated version of the container image if the updated version has a different number of layers compared to the previous version of the container image. In other cases, the software tools can be developed to analyze a particular container image layout, thereby preventing the software tools to be applied to container images in a different format. Additionally or alternatively, the software tools may rely on access to a container registry that can be used to store or access container images.

Some examples of the present disclosure can overcome one or more of the issues mentioned above by updating a container image with deduplication and by comparing files of a target container image with a source container image. An update module of a computing device can determine a set of differences between a current container image and a target container image. The current container image can also be referred to as a source container image. The update module can compare each file of the target container image to one or more files of the current container image to determine a related file that is a closest match with respect to similarity. Based on differences between each file of the target container image and the files of the current container image, the update module can perform deduplication, thereby conserving computing resources, such as storage, of the computing device. In particular, instead of generating duplicate copies of certain files when generating the target container image, the update module can update the files of the current container image to match corresponding files of the target container image based on the differences. Accordingly, the update module can generate the target container image without providing an entirely new container image, thereby minimizing an amount of storage used to update the current container image.

By analyzing each file of the target container image, the update module can determine the set of differences for container images that may have more than one layer, a different number of layers, or a different order of layers. Additionally, individually comparing each file of the target container image to the files of the current container image can increase a likelihood of deduplication, such as due to an increased number of candidates to perform deduplication. For instance, the update module can compare a particular file of the target container image to certain files of the current container image that are in different layers of the current container image. Accordingly, files in more than one layer of the current container image can be candidates to which the particular file is compared to evaluate similarity. In some cases, more than one source container image may be used to generate the target container image.

Additionally, the update module can perform an individual comparison of each file in the target container image to the files of the current container image without access to a container registry or without network access. In some cases, the computing device can be an edge device that can be a resource-constrained device. In other words, the edge device may have limited resources (e.g., storage, processing power, access to networks, etc.) to perform an update related to the current container image. By updating the current container image with deduplication, the update module can perform the container image update with limited or no network access while conserving storage resources of the computing device.

In some cases, the update module can be compatible with container images that are compliant with an image specification of the Open Container Initiative (OCI). The OCI currently includes three specifications: the Runtime Specification, the Image Specification, and the Distribution Specification. The Runtime Specification indicates how to unpack an OCI-compliant image into a filesystem bundle that can be executed to run a corresponding container. The Distribution Specification describes a distribution mechanism used to distribute OCI-compliant container images. The OCI Image Specification defines how to create an OCI-compliant image including an image manifest, a filesystem serialization, and an image configuration. Based on the target and current container images being OCI-compliant, the update module can update the container images regardless of layout of the container images.

In one particular example, a computing device can execute an update module to update a source container image to generate a target container image. The source container image can be a current image version that is currently deployed in the computing device. The target container image can be a known container image. The source container image can include one or more container layers where each container layer can include one or more files. The target container image can have a different number of container layers than the source container image. To determine a set of differences between the source container image and the target container image, the update module can compare each file of the target container image to the files of the source container image. In particular, the update module can compare each file of the target container image to a respective subset of files in separate container layers of the source container image. Using this comparison, the update module can determine whether each file of the target container image is associated with a respective related file of the source container image.

Specifically, the update module can determine a related file of a particular file in the target container image that is most similar to the particular file based on the comparison of the target container image and the source container image. The update module can execute a data comparison between the particular file and the related file to generate an output indicating one or more differences between the particular file and the related file. Additionally, the update module can determine at least one identifier to locate the related file in the source container image. In particular, the at least one identifier can include a layer identifier indicating a particular container layer corresponding to the related file and a file path indicating a location of the related file in a filesystem of the source container image.

The update module can combine the output indicating the differences and the at least one identifier to generate a dataset that can be applied to update the source container image. In particular, the update module can use the at least one identifier to locate the related file in the source container image. Once the related file is located, the update module can modify the related file based on the output generated using the data comparison of the particular file and the related file such that the related file matches the particular file. Accordingly, the update module can modify each related file of the source container image to update the source container image to match the target container image. In some cases, the target container image may include a subset of files that lack a related file or similar file in the source container image. In such cases, the update module can add the subset of files to the source container image to update the source container image to match the target container image.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

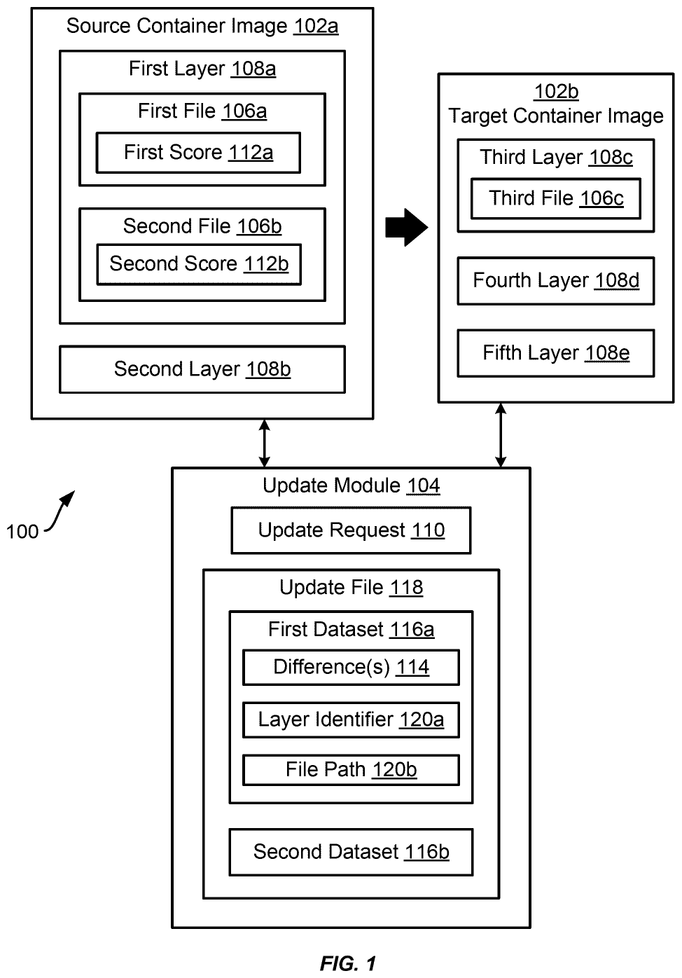

FIG. 1 is a block diagram of an example of a computing environment 100 for updating a container image 102 with deduplication according to some examples of the present disclosure. Components within the computing environment 100 may be communicatively coupled. For example, the computing environment 100 can include one or more container images 102 (e.g., a source container image 102a) that are communicatively coupled with an update module 104. Examples of the computing environment 100 can include a desktop computer, laptop computer, server, mobile phone, or tablet. In some examples, the update module 104 can be an application or another suitable component of the computing environment 100 that can update the container images 102 while the computing environment 100 is offline or disconnected from any networks.

The container images 102 can include one or more files 106 or other suitable components to run a container (e.g., a software application or service) in a self-contained or isolated manner. In some cases, the container images 102 can provide a set of instructions by which to run the container. In some examples, the container images 102 may have been generated to comply with one or more standardized specifications (e.g., an Open Container Initiative (OCI) specification). In other words, the container images 102 can be OCI-compliant container images such that the update module 104 can be layout-agnostic and suitable to update the container images 102 regardless of image layout. Each container image 102 can include one or more container layers 108 that can indicate a set of filesystem changes, such as additions, deletions, or other suitable modifications. As shown in FIG. 1, the source container image 102a includes two container layers: a first container layer 108a and a second container layer 108b.

Each container layer 108 can include a respective set of files, such as operating system files, libraries, configuration files, etc. As shown in FIG. 1, the first container layer 108a of the source container image 102a includes a first file 106a and a second file 106b. The files 106 of each container image 102 can be used to build or run the container. In some examples in which a particular container image has more than one container layer, the container layers may be stacked in a particular arrangement or order. Over time, an update to the container images 102 may be desirable, such as to resolve a vulnerability (e.g., a bug) or to add or remove a functionality implemented by the container images 102. In some cases, the update module 104 may receive an update request 110 that can include information or instructions to perform the update. For instance, the update request 110 may be generated based on user input provided by a user to select a particular container image to be updated and a particular version to which to update the particular container image. In some examples, the update request 110 can identify the source container image 102a, which can indicate to the update module 104 which container image in the computing environment 100 to update.

Updating the container images 102 can involve modifying the container layers 108 of the container images 102, the files 106 of the container images 102, or a combination thereof. For example, an updated version of the source container image 102a (e.g., a target container image 102b) may have a different number of container layers 108, a different order of container layers 108, different files in a particular container layer, etc. As shown, the target container image 102b includes more container layers than the source container image 102a. Specifically, the target container image 102b of FIG. 1 includes a third layer 108c with a third file 106c, a fourth layer 108d, and a fifth layer 108e.

In some implementations, the computing environment 100 may have limited computing resources, such as due to being part of a resource-constrained or edge device. For example, in automotive applications, the computing environment 100 can lack network access and may have limited storage resources or processing power. Additionally, the computing environment 100 may lack access to a container registry or another suitable container repository used to store or access container images. For example, the container registry may be inaccessible in an offline environment that can lack network access. In some cases, the container registry can facilitate creation, management, deployment, or sharing of container images, such as between different computing environments. Certain container registries available offline may consume an amount of storage or processing power that the computing environment 100 may be unable to provide due to its limited computing resources.

To update the container images 102 despite the limited computing resources, the update module 104 can analyze individual files of the source container image 102a or the target container image 102b to perform a container image update with deduplication. In some examples, such as in a controlled computing environment, a current version of a particular container image (e.g., the source container image 102a) can be known. For example, the update module 104 can be aware of or access the source container image 102a and its contents (e.g., the container layers 108a-b). In some cases, the target container image 102b and its contents (e.g., the container layers 108c-e) may also be known. For instance, the update request 110 may include the target container image 102b or suitable information related to the target container image 102b such that the update module 104 can perform a comparison between the container images 102a-b. In particular, the update module 104 can compare the source container image 102a and the target container image 102b to determine how to update the source container image 102a to match the target container image 102b.

In some examples, the update module 104 can perform a file-by-file comparison between each file of the target container image 102b and the files of the source container image 102a. More specifically, the update module 104 can compare a particular file of the target container image 102b to each file in each container layer of the source container image 102a. For example, the update module 104 may compare the third file 106c in the target container image 102b with the first file 106a and the second file 106b in the first container layer 108a of the source container image 102a. The file-by-file comparison can be used to determine a closest match in similarity to the particular file of the target container image 102b. Although the file-by-file comparison is generally described herein as comparing the particular file of the target container image 102b to each file of the source container image 102a, it will be appreciated that this comparison also involves comparing a specific file of the source container image 102a to each file of the target container image 102b.

In some implementations, the comparison of the files can involve a data comparison, such as to determine a degree or amount of similarity between the particular file of the target container image 102b and each file of the source container image 102a. As an example, the update module 104 can implement a line-oriented comparison to determine a smallest set of changes between the particular file of the target container image 102b and the comparison file in the source container image 102a. The changes can include insertions, deletions, or other suitable modifications. In particular, the update module 104 can apply an algorithm to determine a longest sequence of characters present in the particular file and the comparison file in the same order. As another example, the update module 104 may use a string-searching algorithm (e.g., using a rolling hash) to compare the particular file and the comparison file

In some examples, the update module 104 may determine a respective similarity score to quantify the respective amount of similarity between the particular file of the target container image 102b and each file of the source container image 102a. As shown, a first similarity score 112a corresponds to the first file 106a in the source container image 102a and can indicate an amount of similarity between the particular file and the first file 106a. Similarly, a second similarity score 112b is shown to correspond to the second file 106b in the source container image 102a. Although FIG. 1 only shows the third file 106c in the target container image 102b, it will be appreciated that the target container image 102b may include more than one file. The update module 104 can perform the data comparison described herein for each file of the target container image 102b.

Once the update module 104 performs the file-by-file comparison, the update module 104 can determine whether each file of the target container image 102b has a corresponding related file. The related file can be a file of the source container image 102a that is the closest match to a corresponding file in the target container image 102b with respect to similarity. In particular, the similarity scores 112a-b can quantify a respective similarity of the files 106a-b to the third file 106c. As an example, based on the data comparison, the update module 104 may determine that the first file 106a of the source container image 102a is the related file of the third file 106c of the target container image 102b. In some cases, the update module 104 can determine that the first similarity score 112a exceeds a predefined threshold (e.g., a 95% similarity), which can indicate that the first file 106a is the related file. On the other hand, the second similarity score 112b may be below the predefined threshold. Accordingly, the first file 106a may be more similar to the third file 106c than the second file 106b of the source container image 102a. In some examples, if more than one similarity score is above the predefined threshold, the update module 104 may compare a magnitude of similarity scores that exceed the predefined threshold to determine a highest similarity score. The update module 104 then can identify a corresponding file in the source container image 102a with the highest similarity score as the related file.

Based on the comparison, the update module 104 can generate an output (e.g., a diff or a delta) indicating one or more differences 114 between the particular file in the target container image 102b and the related file in the source container image 102a. As described herein, the differences 114 can include insertions, deletions, substitutions, or other suitable modifications to lines of code in the particular file and the related file. In some cases, the output may be provided or generated as part of a dataset 116 (e.g., a first dataset 116a). Other suitable formats or data structures may be used to indicate the differences 114. In some examples in which the target container image 102b includes more than one file, the update module 104 can generate a respective dataset corresponding to each file of the target container image 102b that has a related file in the source container image 102a. For example, the first dataset 116a can correspond to the third file 106c of the target container image 102b. As shown in FIG. 1, the update module 104 can generate a second dataset 116b that can correspond to a different file (not pictured) in the target container image 102b. The update module can include each dataset 116 as part of an update file 118. The update module 104 or another suitable component of the computing environment 100 can use the update file 118 to update the source container image 102a.

In some examples, the dataset 116 can include additional information that can be used to modify the related file in the source container image 102a to match the particular file of the target container image 102b. In particular, the dataset 116 can include at least one identifier 120 by which the related file can be located in the source container image 102a. For example, the dataset 116 can include a layer identifier 120a that can indicate a specific container layer (e.g., the first container layer 108a or the second container layer 108b) in which the related file is located. As another example, the dataset 116 can include a file path 120b that can specify a location of the related file in the specific container layer. In some implementations, the dataset 116 can include the differences 114, the layer identifier 120a, and the file path 120b appended together. For example, the update module 104 can generate the dataset 116 to include the layer identifier 120a and the file path 120b as well as the differences 114.

Once the update module 104 generates the update file 118, the update file 118 can be applied to the source container image 102a to generate the target container image 102b. For example, the update module 104 may modify the source container image 102a based on the update file 118 to generate the target container image 102b. More specifically, the update module 104 may generate an updated version of the related file (e.g., the first file 106a) as part of the target container image 102b by applying the differences 114 included in the dataset 116. The updated version of the related file can match the particular file (e.g., the third file 106c) of the target container image 102b. In some examples in which the update file 118 includes more than one dataset, the update module 104 can apply each dataset to a respective related file of the source container image 102a to update the respective related file.

In some cases, once the update module 104 performs the file-by-file comparison, the update module 104 may determine that the related file of the particular file is not present in the source container image 102a. For instance, the particular file of the target container image 102b may be sufficiently dissimilar or distinct from the files of the source container image 102a. In some examples, the update module 104 may determine that the related file is not present in the source container image 102a based on the similarity scores 112 with respect to the particular file. For example, if the similarity scores 112 are below the predefined threshold, the corresponding files may be sufficiently dissimilar to not be the related file of the particular file. Accordingly, if the update module 104 is unable to determine a related file corresponding to the particular file, the update module 104 can generate the target container image 102b by adding the particular file to the source container image 102a. The update module 104 can add the particular file to the source container image 102a based on how the particular file is provided in the target container image 102b, such as a specific container layer of the target container image 102b. In some examples, the update module 104 may add the particular file to an existing container layer of the source container image 102a. In other examples, the update module 104 may generate a new container layer to be consistent with the target container image 102b.

While FIG. 1 depicts a specific arrangement of components, other examples can include more components, fewer components, different components, or a different arrangement of the components shown in FIG. 1. For instance, in other examples, more than two containers may be present in the computing environment 100. Additionally, any component or combination of components depicted in FIG. 1 can be used to implement the process(es) described herein.

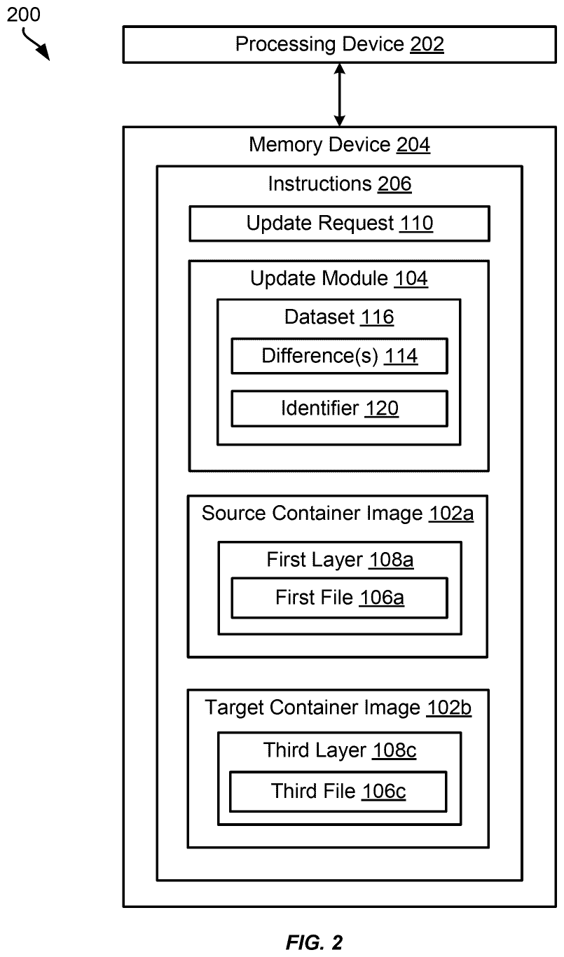

FIG. 2 is a block diagram of a computing device 200 for updating a container image 102 with deduplication according to some examples of the present disclosure. The computing device 200 can include a processing device 202 communicatively coupled to a memory device 204. Certain aspects of FIG. 2 are described below with reference to components of FIG. 1.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206 that are executable by the processing device 202. A computer-readable medium can include electronic, optical, magnetic, or other storage devices capable of providing the processing device 202 with the instructions 206 or other program code executable by the processing device 202. Non-limiting examples of a computer-readable medium include magnetic disk(s), memory chip(s), ROM, random-access memory (RAM), an ASIC, a configured processor, and optical storage.

In some examples, the processing device 202 can execute the instructions 206 to perform one or more operations. For example, the processing device 202 can receive an update request 110 to generate a target container image 102b using a source container image 102a. In some cases, the computing device 200 can include an input device (not pictured) communicatively coupled with the processing device 202. A user can interact with the input device (e.g., a touchscreen, a mouse, a keyboard, etc.) to provide user input to generate the update request 110. The target container image 102b can include one or more modifications that can differentiate the target container image 102b from the source container image 102a, such as by providing new functionality or by reducing vulnerabilities.

Based on the update request 110, the processing device 202 can determine whether a particular file of the target container image 102b corresponds to a related file in the source container image 102a. The processing device 202 can make this determination based on a degree of similarity between the particular file in the target container image 102b and each file in the source container image 102a. In particular, the processing device 202 can compare the particular file to each file in each container layer of the source container image 102a. Additionally, the processing device 202 can perform this comparison for each file in the target container image 102b to determine whether a respective related file exists in the source container image 102a.

In some examples in which the processing device 202 identifies the related file in the source container image 102a, the processing device 202 can generate a dataset 116 corresponding to the related file. For example, the processing device 202 may generate the dataset 116 as part of an update file 118 that can be used to modify the source container image 102a to generate the target container image 102b. The dataset 116 can include one or more differences 114 between the particular file and the related file in the source container image 102a. Additionally, the dataset 116 can include an identifier 120 used to locate the related file in the source container image 102a. Using the identifier 120, the processing device 202 can determine a position of the related file in the source container image 102a such that the processing device 202 can apply the differences 114 to modify the related file. Once the differences 114 are applied, the related file in the source container image 102a can match the particular file of the target container image 102b, thereby updating the source container image 102a to generate the target container image 102b.

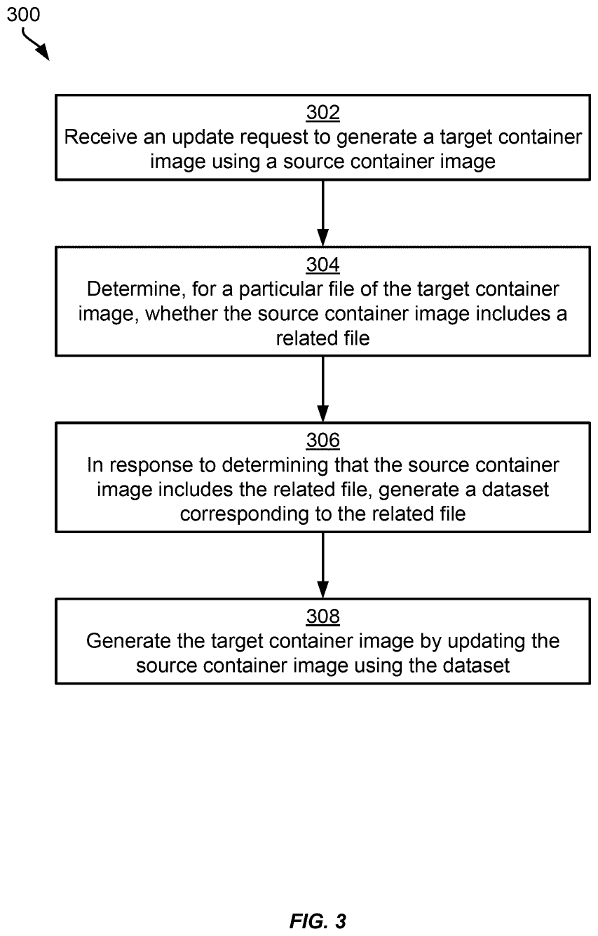

FIG. 3 is a flowchart of a process 300 for updating a container image 102 with deduplication according to some examples of the present disclosure. In some examples, the processing device 202 can perform or execute an update module 104 to perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

In block 302, the processing device 202 receives an update request 110 to generate a target container image 102b using a source container image 102a. The processing device 202 may receive the update request in response to a user interacting with an input device to provide user input to initiate an update of the source container image 102a. The source container image 102a can be a previous version of the target container image 102b. The source container image 102a and the target container image 102b can include a different number of container layers 108. As an example, each container layer 108 can be provided as a tarball that can be a set of files packaged together as a single file that then can undergo compression. Accordingly, each container layer 108 of the source container image 102a and the target container image 102b can include one or more files 106.

In block 304, subsequent to receiving the update request 110, the processing device 202 determines, for a particular file of the target container image 102b, whether the source container image 102a includes a related file corresponding to the particular file. For example, the processing device 202 can compare a file path of the particular file to a respective file path of each file in the source container image 102a. Based on how similar the file path of the particular file is to the respective file paths of the files in the source container image 102a, the processing device 202 can determine whether the related file is present in the source container image 102a. As described herein, the related file can be determined based on its file path having a degree of similarity with the file path of the particular file that exceeds a predefined threshold. In some cases, the source container image 102a may lack the related file, such as if the particular file is a new file instead of a modified file of the source container image 102a.

In block 306, in response to determining that the source container image 102a includes the related file, the processing device 202 generates a dataset 116. The dataset 116 can include one or more differences 114 between the particular file and the related file in the source container image 102a. For example, the processing device 202 can use a rolling hash to determine positions (e.g., certain lines of code) in each file of the source container image 102a that are unlikely to match the particular file. The processing device 202 can implement the rolling hash to convert a sequence of characters (e.g., a string) into a numeric value, such as a hash value. Sequences of characters that are unequal or otherwise different are unlikely to have the same or equal hash values. Accordingly, the processing device 202 can apply the rolling hash to relatively efficiently compare each file of the source container image 102a to the particular file. Additionally, the dataset 116 can include an identifier 120 used to locate the related file in the source container image 102a. For example, the identifier 120 can indicate a specific container layer of the source container image 102a in which the related file is stored. As another example, the identifier 120 can include the file path 120b of the related file.

In block 308, the processing device 202 generates the target container image 102b by updating the source container image 102a using the dataset 116 corresponding to the related file. The processing device 202 can use the identifier 120 to locate the related file. After locating the related file, the processing device 202 can modify the related file based on the differences 114 provided in the dataset 116. For example, based on comparing the particular file and the related file, the processing device 202 may generate a diff file that indicates the differences 114 between the particular file and the related file. The processing device 202 then can use the diff file to update the related file to match the particular file. In some examples, if the processing device 202 is unable to find the related file in the source container image 102a, the processing device 202 can add the particular file to the source container image 102a as part of generating the target container image 102b.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving an update request to generate a target container image using a source container image, the source container image and the target container image comprising a different number of container layers;
determining, for a particular file of the target container image, whether the source container image comprises a related file;
in response to determining that the source container image comprises the related file, generating a dataset comprising one or more differences between the particular file and the related file and an identifier used to locate the related file in the source container image; and
generating the target container image by updating the source container image using the dataset corresponding to the related file.

2. The system of claim 1, wherein determining whether the source container image comprises the related file further comprises:
comparing the particular file of the target container image to each file in each container layer of the source container image; and
subsequent to comparing the particular file to each file in each container layer of the source container image, determining that the source container image comprises the related file as a closest match in similarity to the particular file, wherein a similarity score between the related file and the particular file exceeds a predefined threshold.

3. The system of claim 2, wherein the operations further comprise, subsequent to comparing the particular file of the target container image to each file in each container layer of the source container image:
determining that the related file is not present in the source container image; and
generating the target container image by adding the particular file to the source container image.

4. The system of claim 1, wherein generating the dataset to update the related file further comprises:
determining a layer identifier specifying a particular container layer of the source container image associated with the related file;
determining a file path specifying a location of the related file in the particular container layer of the source container image; and
generating the dataset corresponding to the related file to comprise the layer identifier and the file path.

5. The system of claim 1, wherein updating the source container image using the dataset comprises:
locating, using the identifier included in the dataset, the related file in the source container image; and
subsequent to locating the related file, generating an updated version of the related file by applying the one or more differences included in the dataset to the related file, wherein the updated version of the related file matches the particular file of the target container image.

6. The system of claim 1, wherein the target container image is generated without access to a container registry.

7. The system of claim 1, wherein the source container image and the target container image are compliant with an image specification of the Open Container Initiative (OCI).

8. A method comprising:
receiving an update request to generate a target container image using a source container image, the source container image and the target container image comprising a different number of container layers;
determining, for a particular file of the target container image, whether the source container image comprises a related file;
in response to determining that the source container image comprises the related file, generating a dataset comprising one or more differences between the particular file and the related file and an identifier used to locate the related file in the source container image; and
generating the target container image by updating the source container image using the dataset corresponding to the related file.

9. The method of claim 8, wherein determining whether the source container image comprises the related file further comprises:
comparing the particular file of the target container image to each file in each container layer of the source container image; and
subsequent to comparing the particular file to each file in each container layer of the source container image, determining that the source container image comprises the related file as a closest match in similarity to the particular file, wherein a similarity score between the related file and the particular file exceeds a predefined threshold.

10. The method of claim 9, further comprising, subsequent to comparing the particular file of the target container image to each file in each container layer of the source container image:
determining that the related file is not present in the source container image; and
generating the target container image by adding the particular file to the source container image.

11. The method of claim 8, wherein generating the dataset to update the related file further comprises:
determining a layer identifier specifying a particular container layer of the source container image associated with the related file;
determining a file path specifying a location of the related file in the particular container layer of the source container image; and
generating the dataset corresponding to the related file to comprise the layer identifier and the file path.

12. The method of claim 8, wherein updating the source container image using the dataset comprises:
locating, using the identifier included in the dataset, the related file in the source container image; and
subsequent to locating the related file, generating an updated version of the related file by applying the one or more differences included in the dataset to the related file, wherein the updated version of the related file matches the particular file of the target container image.

13. The method of claim 8, wherein the target container image is generated without access to a container registry.

14. The method of claim 8, wherein the source container image and the target container image are compliant with an image specification of the Open Container Initiative (OCI).

15. A non-transitory computer-readable medium comprising program code executable by a processing device for causing the processing device to perform operations comprising:
receiving an update request to generate a target container image using a source container image, the source container image and the target container image comprising a different number of container layers;
determining, for a particular file of the target container image, whether the source container image comprises a related file;
in response to determining that the source container image comprises the related file, generating a dataset comprising one or more differences between the particular file and the related file and an identifier used to locate the related file in the source container image; and
generating the target container image by updating the source container image using the dataset corresponding to the related file.

16. The non-transitory computer-readable medium of claim 15, wherein determining whether the source container image comprises the related file further comprises:
comparing the particular file of the target container image to each file in each container layer of the source container image; and
subsequent to comparing the particular file to each file in each container layer of the source container image, determining that the source container image comprises the related file as a closest match in similarity to the particular file, wherein a similarity score between the related file and the particular file exceeds a predefined threshold.

17. The non-transitory computer-readable medium of claim 16, wherein the operations further comprise, subsequent to comparing the particular file of the target container image to each file in each container layer of the source container image:
determining that the related file is not present in the source container image; and
generating the target container image by adding the particular file to the source container image.

18. The non-transitory computer-readable medium of claim 15, wherein generating the dataset to update the related file further comprises:
determining a layer identifier specifying a particular container layer of the source container image associated with the related file;
determining a file path specifying a location of the related file in the particular container layer of the source container image; and
generating the dataset corresponding to the related file to comprise the layer identifier and the file path.

19. The non-transitory computer-readable medium of claim 15, wherein updating the source container image using the dataset comprises:
locating, using the identifier included in the dataset, the related file in the source container image; and
subsequent to locating the related file, generating an updated version of the related file by applying the one or more differences included in the dataset to the related file, wherein the updated version of the related file matches the particular file of the target container image.

20. The non-transitory computer-readable medium of claim 15, wherein the target container image is generated without access to a container registry.
